(19) United States
(12) Patent Application Publication
(10) Pub. No.: US 2012/0257147 A1
(43) Pub. Date: Oct. 11, 2012

(54) LIQUID CRYSTAL DISPLAY PANEL AND LIQUID CRYSTAL DISPLAY DEVICE

(76) Inventor: Satoshi Shibata, Osaka-shi (JP)

(21) Appl. No.: 13/515,731

(22) PCT Filed: Sep. 22, 2010
(86) PCT No.: PCT/JP2010/066422

§ 371 Date: Jun. 13, 2012

(30) Foreign Application Priority Data
Dec. 16, 2009 (JP) 2009-285550

(51) Int. Cl. G02F 1/1335

(52) U.S. Cl. 349/96

(57) ABSTRACT

The present invention provides a liquid crystal display panel capable of increasing the contrast not only in the front direction but also in oblique directions, and a liquid crystal display device. The liquid crystal display panel includes a first substrate; a second substrate; and a liquid crystal layer arranged between the first substrate and the second substrate, the liquid crystal display panel including a first O-type polarizing element on an outer side of the first substrate, the liquid crystal display panel including a second O-type polarizing element on an outer side of the second substrate, the liquid crystal display panel including an E-type polarizing element between the second substrate and the liquid crystal layer on an inner side of the second substrate, the liquid crystal display panel including viewing angle compensation film(s) between the first O-type polarizing element and the E-type polarizing element, wherein a thickness-direction phase difference between the first O-type polarizing element and the second O-type polarizing element is equal to or smaller than the thickness-direction phase difference between the first O-type polarizing element and the E-type polarizing element.

### TECHNICAL FIELD

The present invention relates to a liquid crystal display panel and a liquid crystal display device. More specifically, the present invention relates to a liquid crystal display panel having a polarizing element in a liquid crystal cell, and a liquid crystal display device.

### BACKGROUND ART

Liquid crystal display panels are thin and lightweight, and achieve low power consumption. For this reason, liquid crystal display panels are widely used instead of other display devices such as cathode ray tube displays.

A liquid crystal display panel usually has a liquid crystal cell and polarizing plate arranged on the outer sides of the liquid crystal cell. A polarizing plate is generally obtained by laminating a protective film on each side of a polarizing element. A protective film is formed from triacetyl cellulose (TAC), for example.

A polarizing element used is usually one obtained by dyeing a film made of polyvinyl alcohol or the like with iodine, and uniaxially stretching the film (hereinafter, such a polarizing element is also referred to as an “iodine polarizing element”). An iodine polarizing element is what is called an O-type polarizing element, and has an absorption axis in the stretching direction of a film, and a transmission axis in the direction perpendicular to the element plane surface as illustrated in FIG. 15.

The structure of a conventional liquid crystal display panel is specifically described below.

As illustrated in FIG. 16, a transmission-type liquid crystal display panel 101 has a back-side polarizing element 32 and a front-side polarizing element 34, both of which are O-type polarizing elements, on the respective sides of a liquid crystal cell 20.

The liquid crystal cell 20 has a structure in which a liquid crystal layer 26 containing liquid crystal molecules (not illustrated) is arranged between two substrates (a back-side substrate 22, a front-side substrate 24).

In the case that, for example, the liquid crystal display panel 101 is an active-matrix type liquid crystal display panel 101 capable of color display, one of the two substrates is as an array substrate and the other is a color filter substrate. FIG. 16 illustrates an example in which the front-side substrate 24 is a color filter substrate.

On a surface of the front-side substrate 24 as a color filter substrate which faces the liquid crystal layer 26, a color filter 28 is provided.

Here, the back side and the front side of the liquid crystal display panel are not particularly limited. Generally, in a transmission-type liquid crystal display panel, the back side is the side where a backlight is provided, and the front side is the side where the viewer faces the liquid crystal display panel.

### CITATION LIST

### Patent Literature

Patent Document 1: JP 2006-91393 A
Patent Document 2: JP 2007-199237 A
Patent Document 3: JP 2006-330215 A

### SUMMARY OF INVENTION

### Technical Problem

The liquid crystal display panel 101, however, has a problem of viewing angle dependence of the contrast. Hereinafter, the main factors of the viewing angle dependence of the contrast, namely the axis misalignment of polarizing elements, attenuation of absorption anisotropy, and oblique phase difference of the liquid crystal layer, are described.

### (Misalignment of Polarizing Elements)

First, misalignment of polarizing elements is described based on FIGS. 17 and 18. Here, FIGS. 17 and 18 are views each illustrating the crossing angle of absorption axes (an absorption axis D2, an absorption axis D4) of two polarizing elements (the back-side polarizing element 32 having the absorption axis D2, the front-side polarizing element 34 having the absorption axis D4). FIG. 17 is a view in the case of observing the liquid crystal display panel 101 from the front direction (front viewing). FIG. 18 is a view in the case of observing the liquid crystal display panel 101 from an oblique direction (oblique viewing). The front direction of the liquid crystal display panel 101 means the normal direction to the liquid crystal display panel 101.

FIG. 18 shows that, in oblique viewing of the liquid crystal display panel 101, the crossing angle (θ2) of the absorption axes (the absorption axis D2, the absorption axis D4) of the two polarizing elements (the back-side polarizing element 32 having the absorption axis D2, the front-side polarizing element having the absorption axis D4) is smaller than the crossing angle (θ1) in the case of front viewing as illustrated in FIG. 17. More specifically, the crossing angle (θ1) in the case of front viewing is 90°, while the crossing angle (θ2) in the case of oblique viewing is less than 90°.

In this case, the two polarizing elements are no more in the crossed Nicols arrangement. The two polarizing elements cannot achieve favorable black display when they are not in the crossed Nicols arrangement, and thereby cause what is called light leakage in the black state.

The light leakage in the black state is the first factor of the viewing angle dependence of the contrast.

### (Attenuation of Absorption Anisotropy)

The second factor of the viewing angle dependence of the contrast, i.e., attenuation of the absorption anisotropy, is described.

In oblique viewing of a pair of O-type polarizing elements (polarizer and analyzer) arranged in the crossed Nicols while the polarizing elements are rotated (inclined) with the absorption axis of the polarizer as a rotational axis, the light tends to leak as the absorption axis of the analyzer is inclined. This is because the absorption anisotropy of the analyzer observed by the viewer is attenuated by a factor of cos θ as the absorption axis of the analyzer is inclined, owing to the uniaxial absorption anisotropy of the analyzer.

Since the polarizer is rotated with its absorption axis as the rotational axis, the absorption anisotropy of the polarizer is constant regardless of the inclination angle of the absorption axis of the analyzer.

The same phenomenon occurs also in the case of rotating the pair of O-type polarizing elements with the absorption axis of the analyzer as the rotational axis.

The light leakage is the second factor of the viewing angle dependence of the contrast.

### (Oblique Phase Difference of Liquid Crystal Layer)

The third factor of the viewing angle dependence of the contrast, i.e., an oblique phase difference of the liquid crystal layer, is described below.

For example, in the case that liquid crystal molecules in the liquid crystal layer are vertically aligned, the phase difference of the liquid crystal layer is almost zero in the case of front viewing. In contrast, a phase difference arises in the case of oblique viewing.

The phase difference in the liquid crystal layer changes the polarization of the light passing through the liquid crystal cell. The change in the polarization condition of the light is the third factor of the viewing angle dependence of the contrast.

### (Viewing Angle Compensation of Polarizing Element)

To reduce the viewing angle dependence of the contrast, optical compensation is required.

Various methods are possible for the optical viewing angle compensation, particularly the black viewing angle compensation.

### (Phase Difference Film, TAC)

FIG. 19 illustrates the structure for viewing angle compensation using a phase difference film. Here, FIG. 19 is a cross-sectional view illustrating the schematic structure of the liquid crystal display panel 102 with viewing angle compensation using two phase difference films (a back-side phase difference film 36, a front-side phase difference film 46).

As illustrated in FIG. 19, B, G, and R of the color filter 28 respectively indicate blue, green, and red.

The phase difference films (the back-side phase difference film 36, the front-side phase difference film 46) may be protective films formed using TAC (triacetyl cellulose).

As illustrated in FIG. 19, a liquid crystal display panel 102, achieving viewing angle compensation with phase difference films, has phase difference films between the liquid crystal cell 20 and the polarizing elements provided on the outer sides of the liquid crystal cell 20. Specifically, the back-side phase difference film 36 is provided between the back-side substrate 22 of the liquid crystal cell 20 and the back-side polarizing element 32. Similarly, the front-side phase difference film 46 is provided between the front-side substrate 24 of the liquid crystal cell 20 and the front-side polarizing element 34.

In the liquid crystal display panel 102, viewing angle compensation is performed between the two polarizing elements (the back-side polarizing element 32, the front-side polarizing element 34) provided on the outer sides of the liquid crystal cell 20 (that is, in a region L1 between the outer-side polarizing elements).

Such a method using phase difference films allows reduction of light leakage in specific viewing directions, but can be further improved because the light leakage reduction is not achieved in all the viewing angles.

### (In-Cell Polarizing Element)

In the following, an in-cell polarizing element is described. An in-cell polarizing element is used for the purpose of increasing the contrast in the front direction of a liquid crystal display panel in some cases. Hereinafter, such a case is described using FIG. 20. FIG. 20 is a cross-sectional view illustrating a schematic structure of a liquid crystal display panel 103 which achieves viewing angle compensation with an in-cell polarizing element 50. Here, a protective film of the polarizing element and a phase difference film are not illustrated for simplification of the drawing.

As illustrated in FIG. 20, the liquid crystal display panel 103 having the in-cell polarizing element 50 has almost the same structure as the liquid crystal display panel 101 described based on FIG. 16, except that it has the in-cell polarizing element 50 provided between the color filter 28 and the liquid crystal layer 26. That is, the liquid crystal display panel 103 has the color filter 28 on the inner-side surface (surface facing the back-side substrate 22) of the front-side substrate 24, and the in-cell polarizing element 50 is provided on the color filter 28. The liquid crystal display panel 103 has the two polarizing elements (the back-side polarizing element 32, the front-side polarizing element 34) on the outer sides of the liquid crystal cell 20, i.e., at the same positions as those in the liquid crystal display panel 101. That is, three polarizing elements are provided in the liquid crystal display panel 103 (the back-side polarizing element 32, the front-side polarizing element 34, the in-cell polarizing element 50).

Such provision of the in-cell polarizing element 50 enables to increase the contrast in the front direction as described below.

Generally, the color filter 28 has an effect of cancelling polarization of the light passing therethrough. Therefore, polarized light having entered the color filter 28 has a lower degree of polarization when going out of the color filter 28. That is, the color filter 28 functions as a depolarization layer.

The polarized light, having a lower degree of polarization upon passing through the color filter 28, causes light leakage when passing through the front-side polarizing element 34 as an analyzer.

Here, in the liquid crystal display panel 103 having the in-cell polarizing element 50, light having passed through the liquid crystal layer 26 enters the in-cell polarizing element 50 as an analyzer before entering the color filter 28. For this reason, light not having passed through the color filter 28 as a depolarization layer provides monochrome display, achieving high contrast.

In other words, the liquid crystal display panel 103 having the in-cell polarizing element 50 can minimize the amount of polarized light entering the color filter 28, which enables to achieve high contrast in the front direction.

Patent Document 1 and Patent Document 2, for example, mention provision of a polarizing element inside the liquid crystal cell.

### (Contrast Viewing Angle)

Although the liquid crystal display panel 103 having the in-cell polarizing element 50 increases the contrast in the front direction, the liquid crystal display panel 103 decreases the contrast in oblique directions in some cases.

Here, calculation results of the contrast viewing angle in a structure having the absorption axes of two iodine polarizing elements arranged in the crossed Nicols with the absorption axis of one iodine polarizing element as illustrated in FIG. 21 is described. FIG. 22 is an iso-contrast view of the arrangement illustrated in FIG. 21. FIG. 23 illustrates the polar angle dependence of the contrast at azimuth=0°, 45°, and 90° in the arrangement illustrated in FIG. 21. In both FIGS. 22 and 23, the contrast of the middle-layer iodine polarizing element alone was set to 10, and the contrast of each of the upper-layer and lower-layer iodine polarizing elements was set to 20000. The absorption axes of the upper-layer and middle-layer iodine polarizing elements were arranged in parallel with azimuth=0°, and the absorption axis of the lower-layer iodine polarizing element was arranged in parallel with azimuth=90°.

The results shows that an increase in the polar angle especially at azimuth=45° significantly decreases the contrast. That is, the contrast in oblique directions decreases.

### (E-type Polarizing Element)

Meanwhile, Patent Document 3, for example, discloses a technique using an E-type polarizing element as a technique of improving the contrast viewing angle.

An E-type polarizing element has an absorption axis also in the thickness direction of the element, and is formed by, for example, applying to the alignment film a solution that contains a circular-plate-like (disk-like) dichroic pigment and provides lyotropic liquid crystals. As illustrated in FIG. 24, an element formed as above (hereinafter also referred to as a “disc-like pigment polarizing element”) has an absorption axis in the thickness direction as well as in the element plane surface direction, and has a transmission axis in the application direction.

FIG. 25 illustrates calculation results of transmittance distribution of an iodine polarizing element alone. FIG. 26 illustrates calculation results of transmittance distribution of a disc-like pigment polarizing element alone. The transmission axis is arranged in parallel with azimuth=90° in FIG. 25, and the transmission axis is arranged in parallel with azimuth=0° in FIG. 26. In both cases, the contrast of the element alone was set to 20000. As illustrated in FIGS. 25 and 26, the disc-like pigment polarizing element shows a larger transmittance change in the transmission axis direction compared with the iodine polarizing element.

Also, E-type polarizing elements are known to be capable of providing the crossed Nicols state in a wider range than that of O-type polarizing elements.

However, even the technique described in Patent Document 3 using an E-type polarizing element has not been able to sufficiently suppress a decrease in the contrast in oblique directions, i.e., a decrease in the contrast viewing angle.

The present invention has been made in view of the above state of the art, and aims to provide a liquid crystal display panel and a liquid crystal display device which have better contrast not only in the front direction but also in oblique directions.

### Solution to Problem

The present inventor has made various studies on liquid crystal display panels capable of increasing the contrast not only in the front direction but also in oblique directions, and has focused on an in-cell polarizing element and an E-type polarizing element. As a result, the present inventor has found that the contrast viewing angle can be improved in the case that the liquid crystal display panel has a pair of substrates (a first substrate and a second substrate), and a liquid crystal layer arranged between the pair of substrates, the liquid crystal display panel including a first O-type polarizing element on an outer side of one of the substrates (the first substrate), the liquid crystal display panel including a second O-type polarizing element on an outer side of the other of the substrates (the second substrate), the liquid crystal display panel including an E-type polarizing element between the second substrate and the liquid crystal layer on an inner side of the second substrate, the liquid crystal display panel including a viewing angle compensation film between the first O-type polarizing element and the E-type polarizing element, wherein a thickness-direction phase difference between the first O-type polarizing element and the second O-type polarizing element is equal to or smaller than the thickness-direction phase difference between the first O-type polarizing element and the E-type polarizing element. Such a structure has been found to solve the above problem admirably, and thereby the present invention has been completed.

That is, one aspect of the present invention is a liquid crystal display panel, including: a first substrate; a second substrate; and a liquid crystal layer arranged between the first substrate and the second substrate, the liquid crystal display panel including a first O-type polarizing element on an outer side of the first substrate, the liquid crystal display panel including a second O-type polarizing element on an outer side of the second substrate, the liquid crystal display panel including an E-type polarizing element between the second substrate and the liquid crystal layer on an inner side of the second substrate, the liquid crystal display panel including viewing angle compensation film(s) between the first O-type polarizing element and the E-type polarizing element, wherein a thickness-direction phase difference between the first O-type polarizing element and the second O-type polarizing element is equal to or smaller than the thickness-direction phase difference between the first O-type polarizing element and the E-type polarizing element.

According to the present invention, the liquid crystal display panel includes an E-type polarizing element as an in-cell polarizing element between the second substrate and the liquid crystal layer on an inner side of the second substrate. The E-type polarizing element functions as what is called an analyzer.

Since an analyzer is formed at a position close to the liquid crystal layer, a liquid crystal display panel having a high contrast, particularly a high contrast in the front direction, can be obtained.

Also, even in the case of providing a depolarization layer such as a color filter on the second substrate, it is possible to make the first O-type polarizing element and the E-type polarizing element function as a polarizer and an analyzer without the depolarization layer therebetween.

For example, in the case of providing a color filter on the second substrate, disposing an E-type polarizing element on the second substrate and disposing the color filter between the second substrate and the E-type polarizing element allow arrangement of the first O-type polarizing element on the first substrate and the E-type polarizing element respectively as a polarizer and an analyzer, without the depolarization layer (color filter) therebetween. In this case, the first O-type polarizing element functions as a polarizer, and the E-type polarizing element functions as an analyzer.

Here, since the light can be led to the analyzer before passing through the depolarization layer, an increase in the contrast, which is caused when the light passes through the depolarization layer, can be suppressed.

Also, use of the first O-type polarizing element as a polarizer and the E-type polarizing element as an analyzer enables to increase the contrast in oblique directions compared with the case of using an O-type polarizing element as an in-cell polarizing element instead of an E-type polarizing element.

An E-type polarizing element usually has a structure in which disc-like molecules having absorption anisotropy are distributed, as described based on FIG. 24. Therefore, in the case that the first O-type polarizing element is used as a polarizer, the E-type polarizing element is used as an analyzer, and these polarizing elements are arranged in the crossed Nicols, then the absorption anisotropy of the analyzer is almost constant and the absorption axis of the analyzer is hardly inclined even when these polarizing elements are viewed while they are rotated with the absorption axis of the polarizer as the rotational axis. Accordingly, light leakage hardly occurs even when these polarizing elements are viewed while they are rotated with the absorption axis of the polarizer as the rotational axis. That is, the contrast viewing angle in viewing from this direction can be improved.

FIGS. 28 and 29 illustrate calculation results of effects obtained by use of an E-type polarizing element as an in-cell polarizing element. Here, as illustrated in FIG. 27, the contrast viewing angle was calculated as to the structure in which the absorption axis of one O-type polarizing element was arranged in the crossed Nicols with the absorption axes of an E-type polarizing element and another O-type polarizing element. FIG. 28 illustrates an isocontrast view of the arrangement illustrated in FIG. 27. FIG. 29 illustrates the polar angle dependence of the contrast at azimuth=0°, 45°, and 90° of the arrangement illustrated in FIG. 27. In both FIGS. 28 and 29, the contrast of the middle-layer E-type polarizing element alone was set to 10, and the contrast of each of the upper and lower layer O-type polarizing elements was set to 20000. The absorption axes of the upper layer and middle layer polarizing elements were arranged in parallel with azimuth=0°, and the absorption axis of a lower layer polarizing element was arranged in parallel with azimuth=90°.

As a result, a decrease in the contrast in the case that the polar angle, especially at azimuth=45°, can be suppressed compared with the arrangement of FIG. 21 in which only an iodine polarizing element was used. That is, use of an E-type polarizing element as an in-cell polarizing element enables to increase the contrast in oblique directions.

The present invention provides a liquid crystal display panel that has three polarizing elements of a first O-type polarizing element, a second O-type polarizing element, and an E-type polarizing element, and has a viewing angle compensation film between the first O-type polarizing element and the E-type polarizing element.

More specifically, a viewing angle compensation film as well as the liquid crystal layer is provided between the first O-type polarizing element provided on an outer side of the first substrate and the E-type polarizing element provided on an inner side of the second substrate. That is, a viewing angle compensation film is provided between the first O-type polarizing element configured to function as a polarizer and the E-type polarizing element configured to function as an analyzer. Hence, viewing angle compensation of the contrast is facilitated, and can be achieved in a wider range.

According to the present invention, the thickness-direction phase difference between the first O-type polarizing element and the second O-type polarizing element is equal to or smaller than the thickness-direction phase difference between the first O-type polarizing element and the E-type polarizing element.

Accordingly, even in the case of employing a component showing a phase difference between the E-type polarizing element and the second O-type polarizing element, favorable viewing angle characteristics can be easily obtained. More specifically, for example, even in the case of employing a TAC film as a protective film for the second O-type polarizing element, favorable viewing angle compensation can be easily achieved.

As mentioned above, the liquid crystal display panel of the present invention enables to increase the contrast not only in the front direction but also in oblique directions, with its simple structure.

As long as the liquid crystal display panel of the present invention essentially includes these components, the structure of the liquid crystal display panel of the present invention is not particularly limited by other components.

Preferred embodiments of the liquid crystal display panel of the present invention are described in detail below.

It is preferable that the liquid crystal display panel further includes a protective film for the second O-type polarizing element between the E-type polarizing element and the second O-type polarizing element, wherein a difference (ΔRth) in a thickness-direction phase difference between the first O-type polarizing element and the second O-type polarizing element and between the first O-type polarizing element and the E-type polarizing element is substantially the same as a thickness-direction phase difference of the protective film.

Thereby, even if the protective film has a phase difference, favorable viewing angle compensation can be achieved.

Here, “substantially the same” means that the difference between ΔRth and the thickness-direction phase difference of the protective film is preferably 10 nm or smaller, and more preferably 5 nm or smaller.

Here, only a biaxial film may constitute the viewing angle compensation film(s).

Even in the case that only a biaxial film constitutes the viewing angle compensation film between the first O-type polarizing element and the E-type polarizing element as described above, the viewing angle can be compensated. That is, the viewing angle can be compensated using a simple structure.

Here, the following conditions may hold: that is, the liquid crystal display panel further includes a protective film for the second O-type polarizing element between the E-type polarizing element and the second O-type polarizing element, wherein the protective film has an absolute value of the thickness-direction phase difference (phase difference value) of 50 to 65 nm, the liquid crystal layer has a thickness-direction phase difference of 305 to 335 nm, and the biaxial film has an in-plane phase difference of 0 to 30 nm and an absolute value of the thickness-direction phase difference of 210 to 290 nm.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference (phase difference value) of 50 to 65 nm, the liquid crystal layer has a thickness-direction phase difference of 275 to 305 nm, and the biaxial film has an in-plane phase difference of 0 to 30 nm and an absolute value of the thickness-direction phase difference of 180 to 260 nm.

Although the protective films in these structures have phase differences, setting the retardation values as above enables favorable viewing angle compensation.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference (phase difference value) of 5 nm or smaller, the liquid crystal layer has a thickness-direction phase difference of 305 to 335 nm, and the biaxial film has an in-plane phase difference of 5 to 25 nm and an absolute value of the thickness-direction phase difference of 240 to 300 nm.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference (phase difference value) of 5 nm or smaller, the liquid crystal layer has a thickness-direction phase difference of 275 to 305 nm, and the biaxial film has an in-plane phase difference of 5 to 25 nm and an absolute value of the thickness-direction phase difference of 190 to 250 nm.

In these structures, a protective film having almost no thickness-direction phase difference is used. Therefore, the polarization condition of light having passed through the E-type polarizing element is not easily changed before the light enters the second O-type polarizing element. Also, setting the retardation values as described above enables to achieve favorable viewing angle compensation.

Here, only a negative C plate may constitute the viewing angle compensation film(s).

As above, the viewing angle can be compensated even in the case that the liquid crystal display panel includes a negative C plate alone as the viewing angle compensation film between the first O-type polarizing element and the E-type polarizing element. That is, the viewing angle can be compensated using a simple structure.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference (phase difference value) of 50 to 65 nm, the liquid crystal layer has a thickness-direction phase difference of 305 to 335 nm, and the negative C plate has an absolute value of the thickness-direction phase difference of 260 to 300 nm.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference (phase difference value) of 50 to 65 nm, the liquid crystal layer has a thickness-direction phase difference of 275 to 305 nm, and the negative C plate has an absolute value of the thickness-direction phase difference of 240 to 280 nm.

Although the protective films in these structures have phase differences, setting the retardation values as above enables favorable viewing angle compensation.

Here, a positive A plate and a negative C plate which are provided between the first O-type polarizing element and the E-type polarizing element may constitute the viewing angle compensation film(s).

As above, the viewing angle can be compensated even in the case that the liquid crystal display panel includes a positive A plate and a negative C plate as the viewing angle compensation films between the first O-type polarizing element and the E-type polarizing element. That is, the viewing angle can be compensated using a simple structure.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference of 50 to 65 nm, the liquid crystal layer has a thickness-direction phase difference (phase difference value) of 305 to 335 nm, the positive A plate has an in-plane phase difference of 10 to 30 nm, and the negative C plate has an absolute value of the thickness-direction phase difference of 240 to 300 nm.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference of 50 to 65 nm, the liquid crystal layer has a thickness-direction phase difference (phase difference value) of 305 to 335 nm, the positive A plate has an in-plane phase difference of 60 to 80 nm, and the negative C plate has an absolute value of the thickness-direction phase difference of 200 to 260 nm.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference (phase difference value) of 50 to 65 nm, the liquid crystal layer has a thickness-direction phase difference of 275 to 305 nm, the positive A plate has an in-plane phase difference of 10 to 30 nm, and the negative C plate has an absolute value of the thickness-direction phase difference of 220 to 280 nm.

The following conditions may also hold: that is, the liquid crystal display panel further includes a protective film for the second O-type polarizing element between the E-type polarizing element and the second O-type polarizing element, wherein the protective film has an absolute value of the thickness-direction phase difference (phase difference value) of 50 to 65 nm, the liquid crystal layer has a thickness-direction phase difference of 275 to 305 nm, the positive A plate has an in-plane phase difference of 60 to 80 nm, and the negative C plate has an absolute value of the thickness-direction phase difference of 170 to 230 nm.

Although the protective films in these structures have phase differences, setting the retardation values as above enables favorable viewing angle compensation.

The liquid crystal display panel may further include a color filter between the second substrate and the E-type polarizing element.

Even in the case of employing a color filter that functions as a depolarization layer for color display in this way, a polarizer and an analyzer can be arranged without the depolarization layer therebetween as described above.

Therefore, a decrease in the contrast owing to passing through the depolarization layer can be prevented.

The protective film is preferably TAC (triacetyl cellulose), i.e., a TAC film.

Since TAC films are easily available, the protective film can be easily prepared in this case.

Another aspect of the present invention is a liquid crystal display device including the liquid crystal display panel of the present invention.

The liquid crystal display device of the present invention is capable of improving the viewing angle characteristics.

### Advantageous Effects of Invention

The liquid crystal display panel of the present invention can increase the contrast not only in the front direction but also in oblique directions.

The liquid crystal display device of the present invention can improve the viewing angle characteristics.

### BRIEF DESCRIPTION OF DRAWINGS

FIG. 1 is a schematic cross-sectional view illustrating the lamination structure of a liquid crystal display panel of a first embodiment.

FIG. 2 is a schematic cross-sectional view illustrating the lamination structure of a liquid crystal display panel of a comparative structure 1.

FIG. 3 is a view illustrating viewing angle compensation of the liquid crystal display panel of the comparative structure 1 on the Poincare sphere.

FIG. 4 is another view illustrating viewing angle compensation of the liquid crystal display panel of the comparative structure 1 on the Poincare sphere.

FIG. 5 is a schematic cross-sectional view illustrating the lamination structure of a liquid crystal display panel of an embodiment structure 1.

FIG. 6 is a view illustrating an oblique contrast of the liquid crystal display panel of the embodiment structure 1.

FIG. 7 is another view illustrating an oblique contrast of the liquid crystal display panel of the embodiment structure 1.

FIG. 8 is a schematic cross-sectional view illustrating the lamination structure of a liquid crystal display panel of a comparative structure 2.

FIG. 9 is a view illustrating viewing angle compensation of the liquid crystal display panel of the comparative structure 2 on the Poincare sphere.

FIG. 10 is a schematic cross-sectional view illustrating the lamination structure of a liquid crystal display panel of an embodiment structure 2.

FIG. 11 is a schematic cross-sectional view illustrating the lamination structure of a liquid crystal display panel of a comparative structure 3.

FIG. 12 is a schematic cross-sectional view illustrating the lamination structure of a liquid crystal display panel of an embodiment structure 3.

FIG. 13 is a schematic cross-sectional view illustrating the lamination structure of a liquid crystal display panel of a comparative structure 4.

FIG. 14 is a schematic cross-sectional view illustrating the lamination structure of a liquid crystal display panel of an embodiment structure 4.

FIG. 15 is a schematic cross-sectional view illustrating the absorption axis direction of an iodine polarizing element.

FIG. 16 is a schematic cross-sectional view illustrating the lamination structure of a conventional liquid crystal display panel.

FIG. 17 is a view illustrating the crossing angle of absorption axes of two polarizing elements in front viewing.

FIG. 18 is a view illustrating the crossing angle of absorption axes of two polarizing elements in oblique viewing.

FIG. 19 is a cross-sectional view illustrating the lamination structure of a liquid crystal display panel of a comparative embodiment.

FIG. 20 is a cross-sectional view illustrating the lamination structure of a liquid crystal display panel of another comparative embodiment.

FIG. 21 is a schematic view illustrating an arrangement relationship of three iodine polarizing elements.

FIG. 22 is an isocontrast view of the arrangement illustrated in FIG. 21.

FIG. 23 is a polar angle dependence of the contrast of the arrangement illustrated in FIG. 21 at azimuth=0°, 45°, and 90°.

FIG. 24 is a schematic view for explaining the absorption axis direction of a disc-like chromatic polarizing element.

FIG. 25 illustrates calculation results of transmittance distribution of the iodine polarizing element alone.

FIG. 26 illustrates calculation results of transmittance distribution of the disc-like chromatic polarizing element alone.

FIG. 27 is a schematic view illustrating an arrangement relationship of two O-type polarizing elements and one E-type polarizing element.

FIG. 28 is an isocontrast view of the arrangement illustrated in FIG. 27.

FIG. 29 is a polar angle dependency of the contrast of the arrangement illustrated in FIG. 27 at azimuth=0°, 45°, and 90°.

FIG. 30 is a perspective schematic view illustrating an index ellipsoid of a negative C plate.

FIG. 31 is a perspective schematic view illustrating an index ellipsoid of a positive C plate.

### DESCRIPTION OF EMBODIMENTS

The present invention will be described in more detail below with reference to the drawings based on embodiments which, however, are not intended to limit the scope of the present invention.

An in-cell polarizing element herein refers to a polarizing element provided not on an outer side of the liquid crystal cell but inside the liquid crystal cell, specifically in a region between two substrates (the back-side substrate, the front-side substrate) in the liquid crystal cell.

A polarizing element has a function to change natural light to linearly polarized light, and a “polarizing element” herein refers to an element having a polarizing function without a protective film, unless otherwise specified.

Also, an “inner side” refers to the liquid crystal layer side, and an “outer side” refers to the opposite side.

The in-plane phase difference Re is a phase difference (unit: nm) defined as Re=|nx−ny|×d.

Meanwhile, the thickness-direction phase difference Rth is a phase difference (unit: nm) defined as Rth=(nz−(nx+ny)/2)×d.

A negative C plate refers to an optically negative uniaxial plate (film), and specifically refers to a plate having a relationship of nx≈ny>nz as illustrated in FIG. 30.

A positive A plate refers to an optically positive uniaxial plate (film), and specifically refers to a plate having a relationship of nx>ny≈nz as illustrated in FIG. 31.

Also, nx and ny each represent a principal refractive index of the double refraction layer in the in-plane direction, and nz represents a principal refractive index of the double refraction layer in an out-of-plane direction (thickness direction). “d” indicates the thickness (unit: nm) of the double refraction layer. Examples of the double refraction layer include a viewing angle compensation film, and other components such as a liquid crystal cell and a protective film.

In the following description, evaluation and the like of the optical properties include ones obtained through simulation. Hereinafter, comparative structures are also mentioned.

### First Embodiment

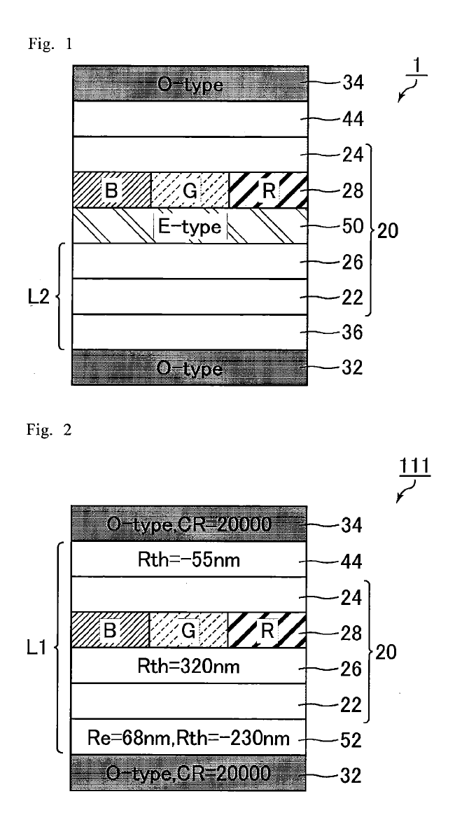

The feature of a liquid crystal display panel 1 of the present embodiment is that an in-cell polarizing element 50 is provided in the liquid crystal cell 20 as illustrated in FIG. 1, and optical compensation, specifically the contrast viewing angle compensation, is made between the back-side polarizing element 32 and the in-cell polarizing element 50 (a region L2 between the back-side polarizing element and the in-cell polarizing element).

That is, the liquid crystal display panel 1 has the same structure as the previously described conventional liquid crystal display panel 101. The liquid crystal display panel 101, however, has only two polarizing elements of the back-side polarizing element 32 and the front-side polarizing element 34 which are O-type polarizing elements. In contrast, the liquid crystal display panel 1 has the in-cell polarizing element 50, which is an E-type polarizing element, inside the liquid crystal cell 20, as well as the two O-type polarizing elements of the back-side polarizing element 32 and the front-side polarizing element 34.

Also, the liquid crystal display panel 101 provides optical viewing angle compensation in the region L1 between outer-side polarizing elements. In contrast, the liquid crystal display panel 1 provides viewing angle compensation in the region L2 between the back-side polarizing element and the in-cell polarizing element.

An E-type polarizing element transmits extraordinary light and absorbs ordinary light. Meanwhile, an O-type polarizing element transmits ordinary light and absorbs extraordinary light.

### (Comparative Structure 1)

First, a liquid crystal display panel 111 of a comparative structure 1 which does not include the in-cell polarizing element 50 is described based on FIG. 2, for comparison with the liquid crystal display panel 1 of the present embodiment.

Here, FIG. 2 is a schematic cross-sectional view illustrating the lamination structure of the liquid crystal display panel of the comparative structure 1.

As illustrated in FIG. 2, the liquid crystal display panel 111 has an optical film (viewing angle compensation film) on both outer sides (the front side, the back side) of the liquid crystal cell 20.

The liquid crystal cell 20 is provided with the back-side substrate 22, the front-side substrate 24, the liquid crystal layer 26, and the color filter 28.

The liquid crystal layer 26 is arranged between the two substrates 22 and 24. The liquid crystal layer 26 has an Rth of 320 nm under no voltage application, and the liquid crystal material used is nematic liquid crystals having a refractive index anisotropy, defined as Δn=ne−no, of 0.1. The liquid crystal layer 26 has a thickness (cell gap) of 2.67 μm. The liquid crystal cell 20 is of a vertical alignment type with a pre-tilt angle of 89.9°.

The color filter 28 functioning as a depolarization layer is provided on the back-side substrate 22 side of the front-side substrate 24.

The production method of the liquid crystal cell 20 can be a conventionally used method. That is, one of the back-side substrate 22 and the front-side substrate 24 has a supporting material (such as spacer beads and a photospacer) for maintaining a cell gap, and the substrates 22 and 24 are attached to each other with the supporting material therebetween.

The substrates 22 and 24 are sealed therearound by a sealing material.

A liquid crystal material may be injected between the substrates 22 and 24 after attachment of these substrates, or a liquid crystal material may be dropped onto one of the substrates before attachment of these substrates.

An optical film (viewing angle compensation film) may be provided on each outer side of the liquid crystal cell

Specifically, a protective film 44 is provided on the surface of the front-side substrate 24 opposite to the back-side substrate 22 side surface (i.e., on the front-side surface), and the front-side polarizing element 34 is provided on the protective film 44. The protective film 44 is formed using TAC, and has a thickness of 80 μm and an Rth of −55 nm. The front-side polarizing element 34 has a contrast (CR) of 20000.

A protective film (e.g., TAC film) may be provided on the surface of the front-side polarizing element 34 opposite to the back-side substrate 22 side surface (i.e., on the front-side surface).

A back-side biaxial film 52 is provided on the surface of the back-side substrate 22 opposite to the front-side substrate 24 side surface (i.e., on the back-side surface), and the back-side polarizing element 32 is provided on the biaxial film 52. Here, Re of the back-side biaxial film 52 is 68 nm, and Rth is −230 nm. The contrast of the back-side polarizing element 32 is 20000 which is the same as that of the front-side polarizing element 34.

A protective film (e.g., TAC film) may be provided on the surface of the back-side polarizing element 32 opposite to the back-side substrate 22 side surface (i.e., on the front-side surface).

Each of the front-side polarizing element 34 and the back-side polarizing element 32 can be an iodine polarizing element. Also, a polarizing element including wire grids (i.e., a wire grid polarizing element) may be used.

In the case of using a wire grid polarizing element, a polarizing plate including a wire grid polarizing element produced separately may be attached to each of the front-side substrate 24 and the back-side substrate 22, or a wire grid polarizing element may be directly formed on each of the front-side substrate 24 and the back-side substrate 22. That is, for example, fine lines/spaces (recessed/projected portions) may be formed on the front-side substrate 24 and the back-side substrate 22 by the nanoimprint method, and a metallic material such as aluminum and silver may be deposited on the recessed/projected portions.

In the liquid crystal display panel 111, viewing angle compensation is made between the region L1 between the outer-side polarizing elements (between the back-side polarizing element 32 and the front-side polarizing element 34). Hereinafter, the mechanism of the viewing angle compensation of the comparative structure 1 is described using the Poincare sphere.

### (Poincare Sphere)

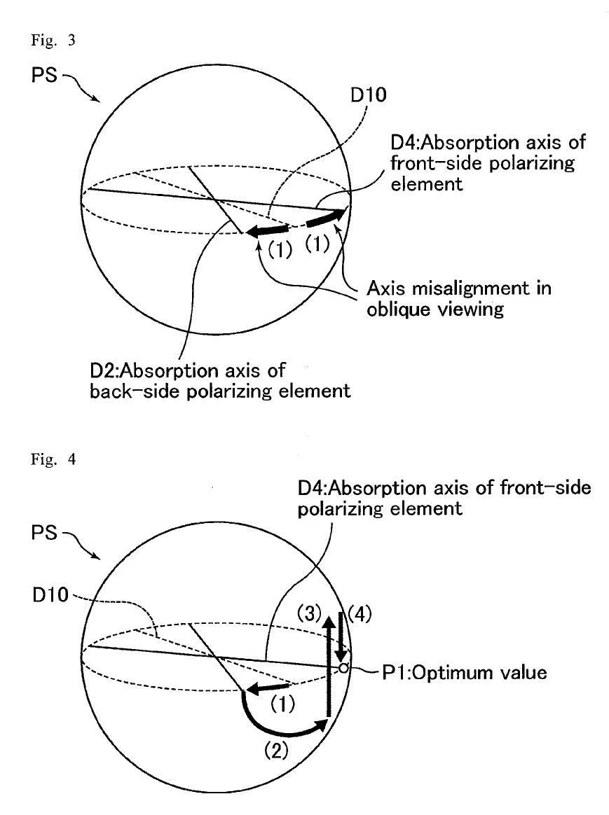

FIG. 3 is a view illustrating the position of the absorption axes of the outer-side polarizing elements on a Poincare sphere PS.

### (Axis Misalignment)

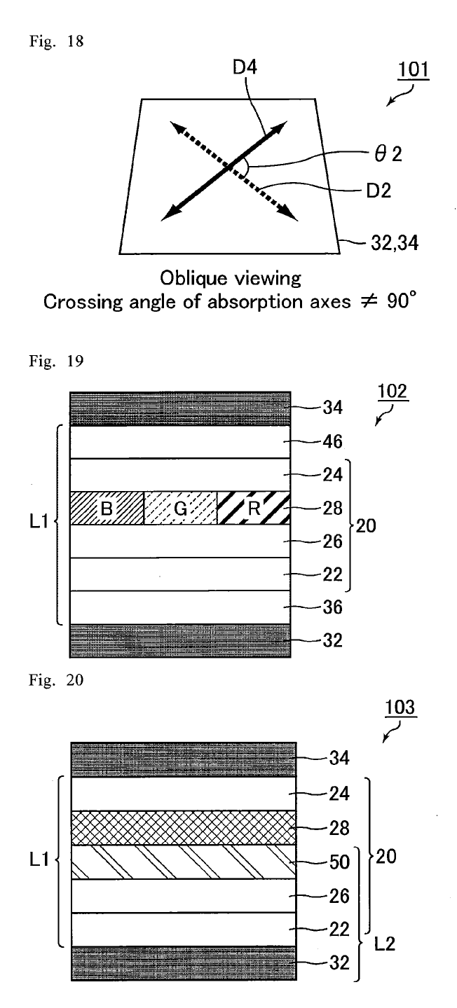

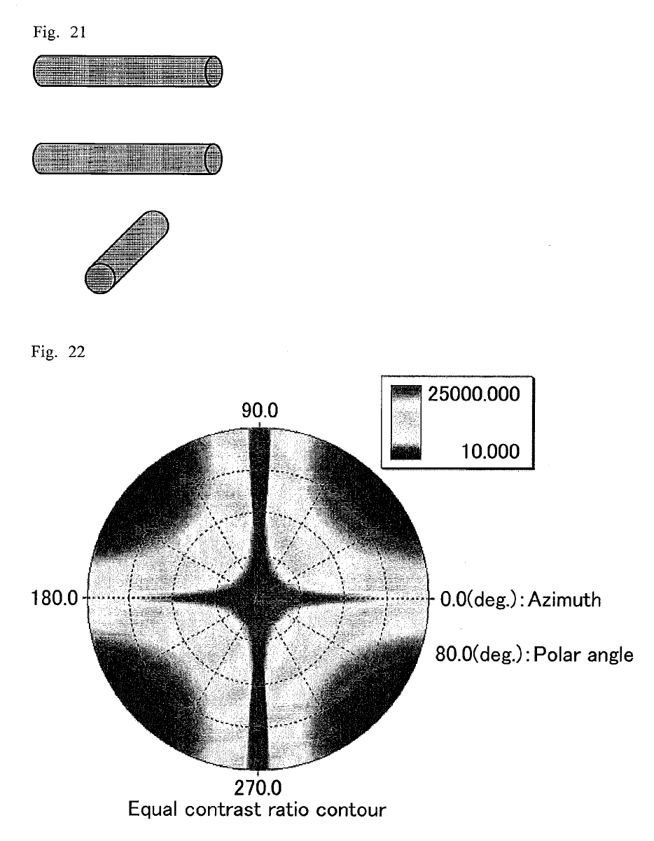

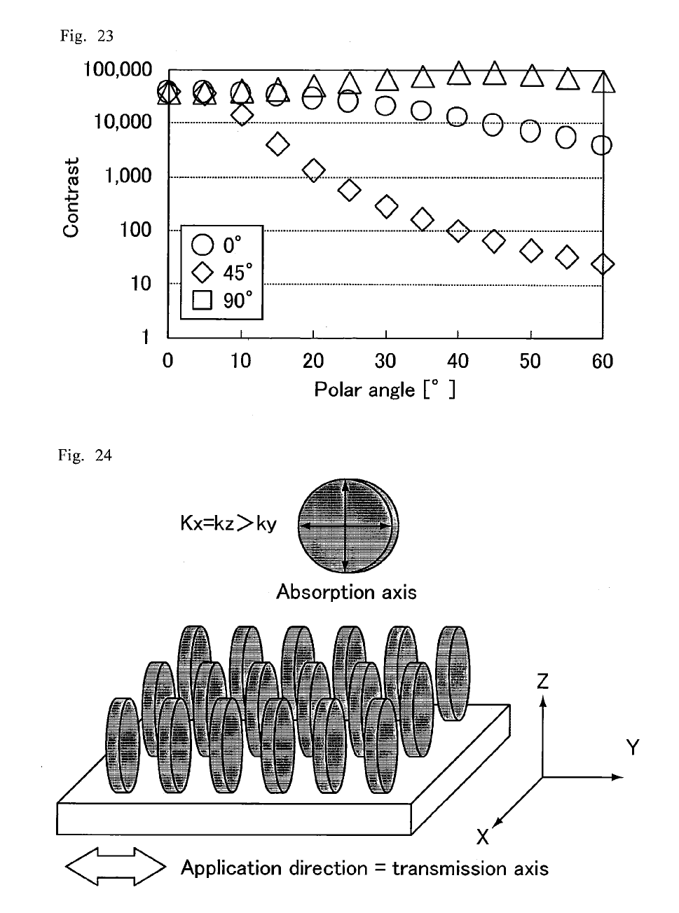

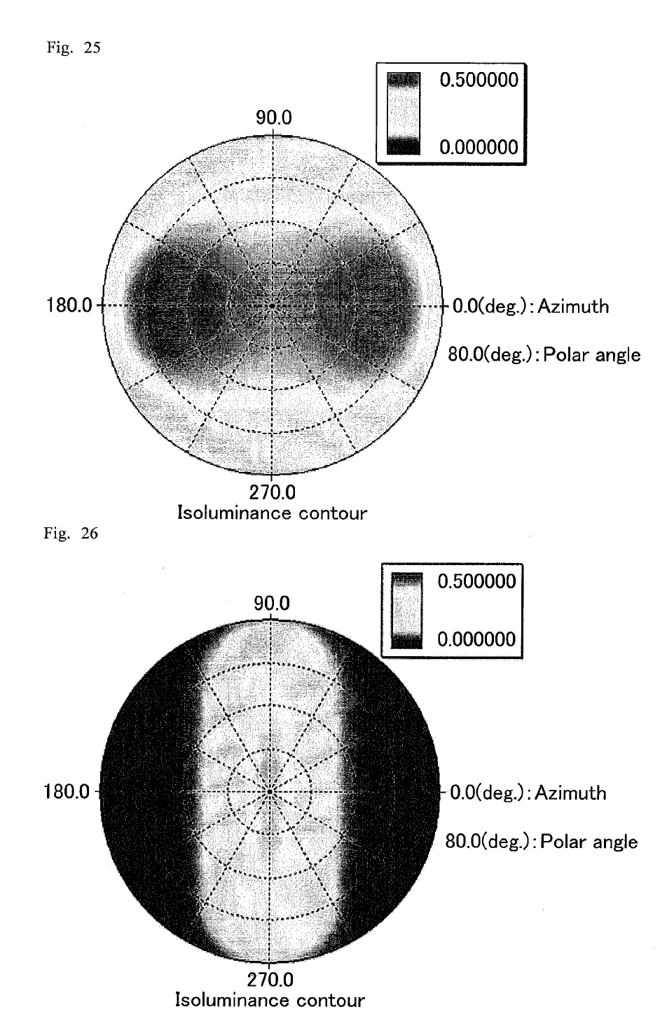

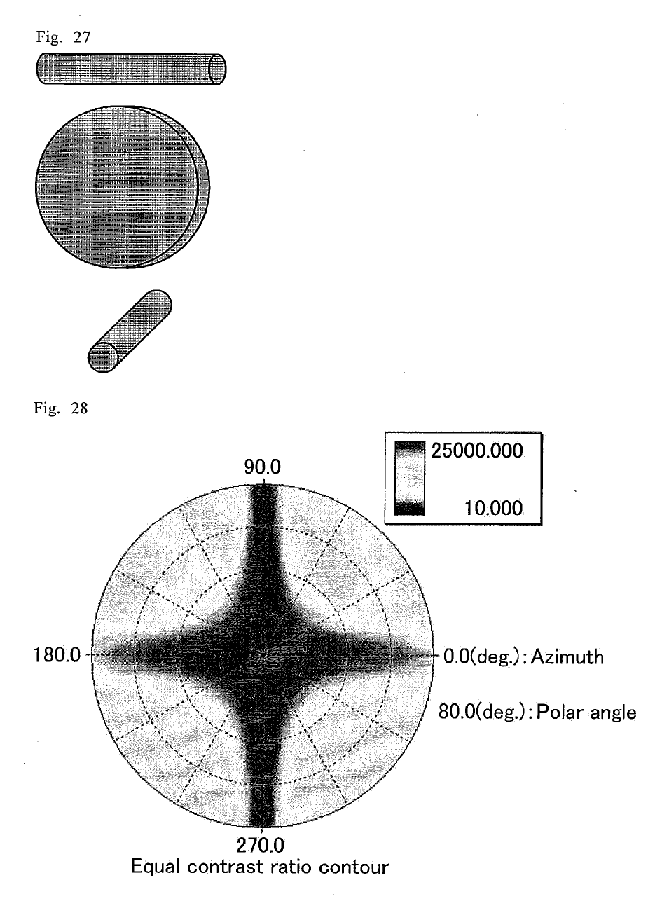

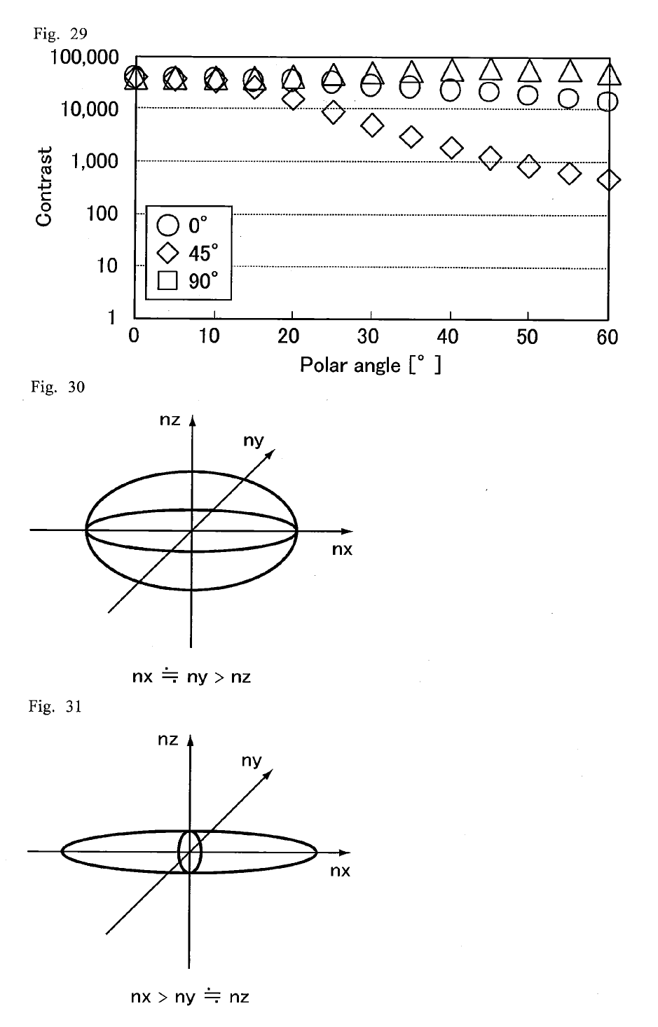

As illustrated in FIG. 18, in oblique viewing of two polarizing elements of which the absorption axes cross at a right angle, the crossing angle θ2 is not 90° anymore.

The Poincare sphere PS of FIG. 3 illustrates a difference of the absorption axis D2 of the back-side polarizing element 32 and the absorption axis D4 of the front-side polarizing element 34 from the absorption axis (D10) in front viewing. That is, the arrows (1) on the Poincare sphere PS show the axis misalignment of the back-side polarizing element 32 and the axis misalignment of the front-side polarizing element 34.

Here, the liquid crystal display panel 111 eliminates the effects of axis misalignment using a viewing angle compensation film, and provides favorable black display even in oblique viewing. Hereinafter, description is made based on FIG. 4.

### (Viewing Angle Compensation (Comparative Structure 1))

FIG. 4 is a view illustrating the viewing angle compensation of the liquid crystal display panel 111 of the comparative structure 1 on the Poincare sphere PS.

As illustrated in FIG. 4, the liquid crystal display panel 111 sequentially converts the polarization condition of the light emitted from the back-side polarizing element 32 using the phase difference film ((2) in FIG. 4) such as the back-side biaxial film 52, the liquid crystal cell (VA) 20 ((3) in FIG. 4), and the protective film 44 ((4) in FIG. 4) which functions as a negative C plate. At the time that the light enters the front-side polarizing element 34, the polarization condition of the light is changed on the misaligned absorption axis (on the absorption axis D4 of the front-side polarizing element) (see the optimum value P1 of FIG. 4).

As above, since the polarization condition of the light entering the front-side polarizing element 34 is changed on the misaligned absorption axis D4, favorable black display is possible even in oblique viewing.

The total −C component in the comparative structure 1 is 35 nm from back-side biaxial film=−230 nm, liquid crystal layer=320 nm, and protective film (TAC film)=−55 nm. Since favorable black display is achieved with this structure, the optimum −C component value for favorable black display is considered to be 35 nm.

In the liquid crystal display panel 111, viewing angle compensation is achieved between the outer-side polarizing elements (the back-side polarizing element 32 and the front-side polarizing element 34) (i.e., in the region L1 between the outer-side polarizing elements).

Accordingly, polarized light having entered the color filter 28 has a lower degree of polarization upon passing through the color filter 28. The light having a lower degree of polarization causes light leakage when passing through the front-side polarizing element 34 as an analyzer. That is, the contrast decreases.

### (Embodiment Structure 1)

To solve this problem, a liquid crystal display panel 11 having the structure (an embodiment structure 1) according to the first embodiment includes the in-cell polarizing element 50 (an E-type polarizing element) in the liquid crystal cell 20, so that viewing angle compensation is achieved in the region L2 between the back-side polarizing element and the in-cell polarizing element. In order to optimize the viewing angle compensation in the region L2 between the back-side polarizing element and the in-cell polarizing element, a back-side biaxial film 52 providing the optimized retardation is disposed.

The in-cell polarizing element 50 is formed using a lyotropic liquid crystalline dichroic pigment, or polymerizable liquid crystals containing a dichroic pigment.

In the case of forming the in-cell polarizing element 50 from such materials, it is preferable to apply an alignment film material (e.g., polyimide) to the color filter 28 to form an alignment film, and performing alignment treatment, such as rubbing treatment, on the alignment film. Applying the above material of the in-cell polarizing element 50 to the alignment film having been subjected to alignment treatment enables to form a uniformly aligned E-type polarizing element.

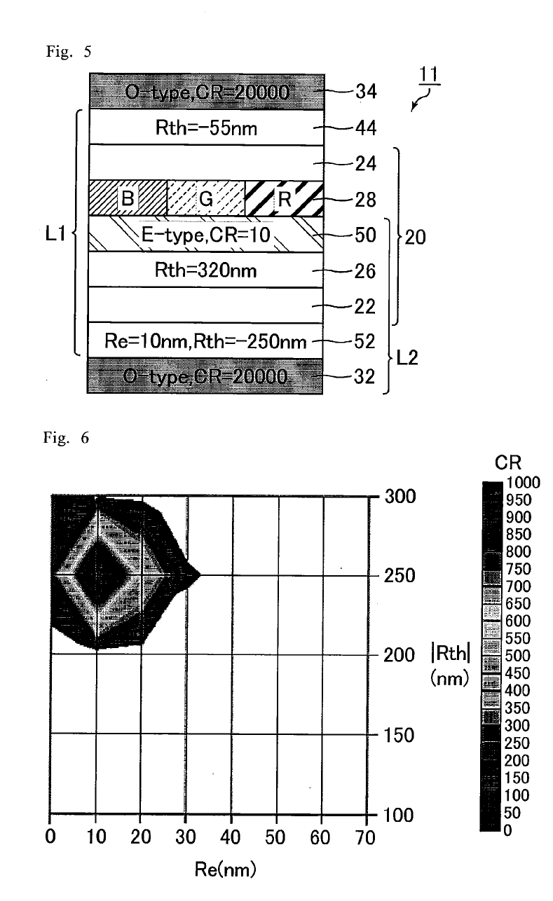

FIG. 5 is a schematic cross-sectional view illustrating the lamination structure of the liquid crystal display panel of the embodiment structure 1. As illustrated in FIG. 5, the liquid crystal display panel 11 of the embodiment structure 1 has almost the same structure as the liquid crystal display panel 111 of the comparative structure 1.

The difference between these is that the in-cell polarizing element 50 is provided and the retardations of the back-side biaxial films 52 are different.

The back-side biaxial film 52 in the comparative structure 1 achieves retardation with Re=10 nm and Rth=−250 nm, and the back-side biaxial film 52 in the embodiment structure 1 achieves retardation with Re=68 nm and Rth=−230 nm. The contrast of the in-cell polarizing element 50 is 10, and the single transmittance is 45%.

That is, a biaxial film providing the optimum retardation to the liquid crystal display panel 11 including the in-cell polarizing element 50 is newly designed, and the biaxial film is used as a back-side biaxial film 52.

The transmission axis of the in-cell polarizing element 50 and the transmission axis of the front-side polarizing element 34 are arranged to be substantially parallel with each other, and the transmission axis of the in-cell polarizing element 50 and the transmission axis of the back-side polarizing element 32 are arranged to be substantially perpendicular to each other. More specifically, the angle formed by the transmission axis of the in-cell polarizing element 50 and the transmission axis of the front-side polarizing element 34 is ±0.5° or smaller (suitably ±0.3° or smaller), and the angle formed by the transmission axis of the in-cell polarizing element 50 and the transmission axis of the back-side polarizing element 32 is 89.5° or greater and 90.5° or smaller (suitably 89.7° or greater and 90.3° or smaller).

The total −C component in the region L2 between the back-side polarizing element and the in-cell polarizer in the liquid crystal display panel 11 having the embodiment structure 1 is 70 nm from back-side biaxial film=−250 nm and liquid crystal layer=320 nm.

In consideration of the misalignment tolerable range from the designed retardation value (specifically ±60 nm from the designed value), the above value is in the tolerable range (±60 nm) from the previously described optical value (35 nm).

The polarization conversion using a biaxial film is affected by phase differences of the in-plane phase difference (Re) and the thickness-direction phase difference (Rth).

The total −C component in the region L1 between the outer-side polarizing elements in the liquid crystal display panel 11 is 15 nm from back-side biaxial film=−250 nm, liquid crystal layer=320 nm, and protective film (TAC film)=−55 nm.

This value is in the above tolerable range (±60 nm) from the optimum value (35 nm) previously described. That is, the total Rth of the liquid crystal display panel 11 is −20 nm from the optimum value, which means that the viewing angle of the liquid crystal display panel 11 is compensated.

As mentioned above, the −C component (Rth) in the region L1 between the outer-side polarizing elements is smaller than the −C component (Rth) in the region L2 between the back-side polarizing element and the in-cell polarizer. In both of the region L2 between the back-side polarizing element and the in-cell polarizing element and the region L1 between the outer-side polarizing elements, the −C components are in the tolerable range although being off the optimum values.

Accordingly, the liquid crystal display panel 11 having the embodiment structure 1 can achieve favorable black display.

The optimum value of the phase difference in viewing angle compensation means an in-plane phase difference and a thickness-direction phase difference between the first O-type polarizing element and the second O-type polarizing element which change the polarization condition of the polarized light, emitted from the polarizer, to the polarization condition agreeable with the absorption axis of the analyzer, right before the polarized light enters the analyzer.

In the liquid crystal display panel 1 of the present embodiment in which the back-side polarizing element (first O-type polarizing element) 32, the front-side polarizing element (second O-type polarizing element) 34, and the in-cell polarizing element (E-type polarizing element) 50 are used, the back-side polarizing element 32 serves as a polarizer, the in-cell polarizing element 50 serves as a first analyzer, and the front-side polarizing element 34 serves as a second analyzer.

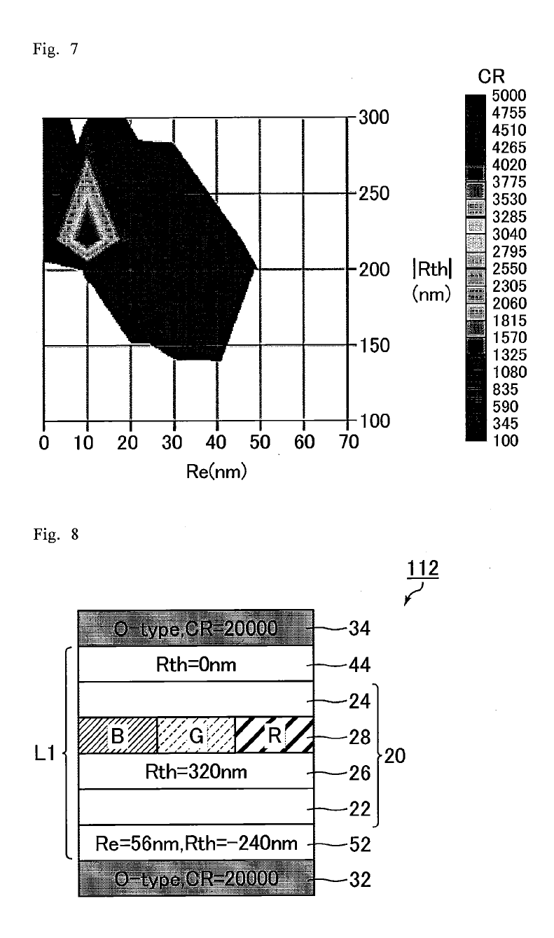

Here, the contrast of the embodiment structure 1 in the case of changing the retardation of the liquid crystal layer 26 and the retardation of the back-side biaxial film without changing the other settings is described based on FIGS. 6 and 7. FIGS. 6 and 7 illustrate the contrast of the liquid crystal display panel 11 in the case of changing the retardation of the liquid crystal layer 26 and the retardation of the back-side biaxial film.

More specifically, FIG. 6 illustrates the case that the retardation of the liquid crystal layer 26 is Rth=320 nm, and FIG. 7 illustrates the case that the retardation of the liquid crystal layer 26 is Rth=290 nm.

The contrast illustrated in FIGS. 6 and 7 is a contrast in observation with azimuth=45° and polar angle=60° (hereinafter, such a contrast is also referred to as an “oblique contrast”).

The azimuth means a rotational angle in the counter clockwise direction from the 0° position (i.e., an angle from the 0° position) in the rectangular coordinates formed by virtual lines drawn along the longitudinal direction and short side direction, in the liquid crystal display panel 1 having an approximately rectangular shape.

The polar angle means an inclination angle from the normal direction on the surface of the liquid crystal display panel 1 (surface of the front-side polarizing element 34).

The oblique contrast is preferably kept to be 20 or higher such that the light leakage in the black state in oblique viewing can be sufficiently reduced.

FIG. 6 shows that an oblique contrast of 20 or higher was secured in the case that the liquid crystal layer 26 satisfies Rth=305-335 nm (preferably 310 to 330 nm) and the back-side biaxial film 52 satisfies Re=0 to 30 nm (preferably 5 to 25 nm) and Rth=−210 to −290 nm (preferably −240 to −260 nm).

FIG. 7 shows that an oblique contrast of 20 or higher was secured in the case that the liquid crystal layer 26 satisfies Rth=275 to 305 nm (preferably 280 to 300 nm) and the back-side biaxial film 52 satisfies Re=0 to 30 nm (preferably 5 to 15 nm) and Rth=−180 to −260 nm (preferably −210 to −230 nm).

As above, the liquid crystal display panel of the first embodiment and the liquid crystal display panel having the embodiment structure 1, both provided with an in-cell polarizing element, achieve favorable viewing angle compensation.

A conventional liquid crystal display panel without an in-cell polarizing element is only required to cancel the phase difference between the outer-side polarizing elements. Hence, such a liquid crystal display panel can be designed to achieve viewing angle (black) compensation for a total of the phase difference of the protective film (TAC film) of the front-side polarizing element, the phase difference of the liquid crystal layer, and the phase difference of the protective film (TAC film) of the back-side polarizing element, which has led to a wide design margin.

In contrast, a conventional liquid crystal display panel provided with an in-cell polarizing element is required to achieve viewing angle compensation between the back-side polarizing element and the in-cell polarizing element. In the case of achieving viewing angle compensation between the back-side polarizing element and the in-cell polarizing element, the phase difference of the protective film (phase difference of a TAC film) of the front-side polarizing element cannot be compensated. That is, the phase difference remains as a residual phase difference without being compensated. This residual phase difference causes light leakage in the black state.

The liquid crystal display panel of the first embodiment and the liquid crystal display panel having the first embodiment structure are designed to provide favorable black display even in the case that the phase difference of the protective film 44 remains.

In other words, assuming that, for example, a TAC film as the protective film 44 is provided on the front-side polarizing element 34, perfect phase difference compensation when the light passes through the in-cell polarizing element 50 causes the phase difference of the TAC film to be excessive. As a result, the light will pass through the front-side polarizing element 34. That is, light leakage occurs to produce grayish black.

For this reason, the liquid crystal display panel of the first embodiment and the liquid crystal display panel having the embodiment structure 1 are designed to provide as low compensation as the light leakage in the black state does not occur when the light passes through the in-cell polarizing element 50. In consideration of the additional phase difference of the protective film 44, the liquid crystal display panels are designed to provide a high total compensation. Accordingly, favorable black display can be obtained.

More specifically, in the case of employing a TAC film with Rth being −50 nm to −65 nm (suitably −55 to −60 nm) as the protective film 44, the following three conditions are more preferably satisfied. The first condition is that the viewing angle compensation films are gathered between the back-side polarizing element 32 and the in-cell polarizing element 50. The second condition is that the thickness-direction phase difference between the back-side polarizing element 32 and the in-cell polarizing element 50 is set to be +25 nm or more and +45 nm or less from the optimum value. The third condition is that the thickness-direction phase difference between the back-side polarizing element 32 and the front-side polarizing element 34 is set to be −30 nm or more and −10 nm or less from the optimum value.

Here, the difference (shortage) from the optimum value of the thickness-direction phase difference between the back-side polarizing element 32 and the in-cell polarizing element 50 and the difference (excess) from the optimum value of the total thickness-direction phase difference between the back-side polarizing element 32 and the front-side polarizing element 34 are not necessarily the same, and can be respectively set to suitable values.

The protective film 44 may be a TAC film having a thickness of 40 μm and Rth=−25 to −35 nm (suitably about −27 nm to about −30 nm). In this case, the Rth of the protective film 44 may be divided into the retardation before passing of the light through the in-cell polarizing element 50 and the retardation after passing of the light through the in-cell polarizing element 50.

### Second Embodiment

Hereinafter, the second embodiment is described. The structure of the liquid crystal display panel is the same as that of the first embodiment, except the parts described in the present embodiment. For convenience of explanation, components having the same function as those described in the drawings for the first embodiment are indicated by the same reference signs, and explanation therefor is omitted.

The Rth of the protective film 44 of a liquid crystal display panel 2 of the present embodiment is substantially 0 nm (suitably −5 nm or greater, +5 nm or smaller), differently from the liquid crystal display panel 1 of the first embodiment.

### (Second Comparative Structure)

First, a liquid crystal display panel 112 of a comparative structure 2 which does not have the in-cell polarizing element 50 is described based on FIG. 8, for comparison with the liquid crystal display panel of the present embodiment.

As illustrated in FIG. 8, the liquid crystal display panel 112 having the comparative structure 2 has almost the same structure as the liquid crystal display panel 111 having the comparative structure 1.

Here, the retardations of the protective film 44 and the back-side biaxial film 52 are different. That is, in the comparative structure 1, the protective film 44 has an Rth of −55 nm and the back-side biaxial film 52 has an Re of 68 nm and an Rth of −230 nm, whereas in the comparative structure 2, the protective film 44 has an Rth of 0 nm and the back-side biaxial film 52 has an Re of 56 nm and an Rth of −240 nm. Hereinafter, the mechanism of the viewing angle compensation in the comparative structure 2 is explained using the Poincare sphere.

### (Viewing Angle Compensation (Comparative Structure 2))

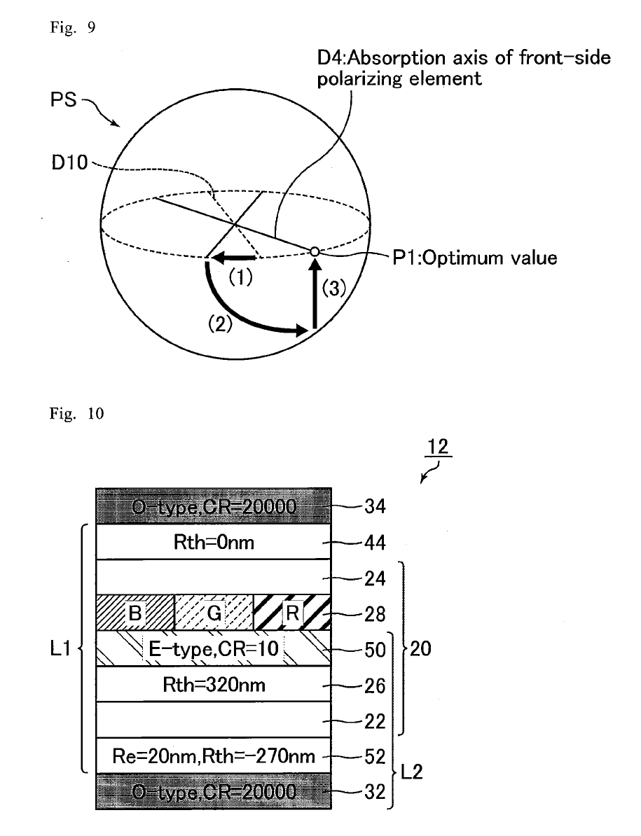

FIG. 9 is a view illustrating the viewing angle compensation of the liquid crystal display panel 112 having the comparative structure 2 on a Poincare sphere PS.

In the liquid crystal display panel 112, similarly to the liquid crystal display panel 111, the crossing angle θ2 is not 90° anymore in oblique viewing of two polarizing elements of which the absorption axes are perpendicular to each other.

The differences of the absorption axis D2 of the back-side polarizing element 32 and the absorption axis D4 of the front-side polarizing element 34 from the absorption axis (D10) in the front viewing are illustrated by an arrow (1) on the Poincare sphere PS in FIG. 9.

As illustrated in FIG. 9, the polarization condition of the light emitted from the back-side polarizing element 32 of the liquid crystal display panel 112 is sequentially changed by the phase difference films such as the back-side biaxial film 52 (polarization indicated as (2) in FIG. 9) and the liquid crystal cell (VA) 20 (polarization indicated as (3) in FIG. 9). When the light enters the front-side polarizing element 34, the polarization condition of the light is changed to be on the misaligned absorption axis (on the absorption axis D4 of the front-side polarizing element) (see the optimum value P1 in FIG. 9).

In this way, the polarization condition of the light entering the front-side polarizing element 34 is changed to be on the misaligned absorption axis D4, which enables favorable black display even in oblique viewing.

The total −C component in the present comparative structure 2 is 80 nm from back-side biaxial film=−240 nm, liquid crystal layer=320 nm, and protective film (TAC film)=0 nm. Since favorable black display can be achieved with this structure, the optimum −C component value for achieving favorable black display is considered to be 80 nm.

In the liquid crystal display panel 112, viewing angle compensation is achieved between the outer-side polarizing elements (the back-side polarizing element 32 and the front-side polarizing element 34) (i.e., in the region L1 between the outer-side polarizing elements).

Accordingly, polarized light having entered the color filter 28 has a lower degree of polarization upon passing through the color filter 28. The light having a lower degree of polarization causes light leakage when passing through the front-side polarizing element 34 as an analyzer. That is, the contrast decreases.

### (Embodiment Structure 2)

In a liquid crystal display panel 12 having a structure (an embodiment structure 2) according to the second embodiment includes the in-cell polarizing element 50 (an E-type polarizing element) in the liquid crystal cell 20, so that viewing angle compensation is provided in the region L2 between the back-side polarizing element and the in-cell polarizing element. Also, for optimization of the viewing angle compensation in the region L2 between the back-side polarizing element and the in-cell polarizing element, the back-side biaxial film 52 exhibiting optimized retardation is provided.

FIG. 10 is a schematic cross-sectional view illustrating the lamination structure of the liquid crystal display panel having the embodiment structure 2. As illustrated in FIG. 10, the liquid crystal display panel 12 having the embodiment structure 2 has almost the same structure as the liquid crystal display panel 11 having the comparative structure 1.

Here, the retardations of the protective film 44 and the back-side biaxial film 52 are different. That is, in the embodiment structure 1, the protective film 44 has an Rth of −55 nm and the back-side biaxial film 52 has an Re of 10 nm and an Rth of −250 nm, whereas in the embodiment structure 2, the protective film 44 has an Rth of 0 nm and the back-side biaxial film 52 has an Re of 20 nm and an Rth of −270 nm.

Here, The total −C component in the region L2 between the back-side polarizing element and the in-cell polarizer in the liquid crystal display panel 12 having the embodiment structure 2 is 50 nm from back-side polarizing element=−270 nm and liquid crystal layer=320 nm.

This value is within the tolerable range (±60 nm) from the optimum value (35 nm) described above.

The total −C component in the liquid crystal display panel 12 is 50 nm from back-side biaxial film=−270 nm, liquid crystal layer=320 nm, and protective film (TAC film)=0 nm, similarly to the total −C component in the region L2 between the back-side polarizing element and the in-cell polarizing element.

This value is within the tolerable range (±60 nm) from the optimum value (80 nm) described above. That is, the total Rth of the liquid crystal display panel 12 is −30 nm from the optimum value, which means that the viewing angle of the liquid crystal display panel 12 is compensated.

As above, in the embodiment structure 2, the −C component (Rth) in the region L1 between the outer-side polarizing elements is substantially the same as the −C component (Rth) in the region L2 between the back-side polarizing element and the in-cell polarizer. In both of the region L2 between the back-side polarizing element and the in-cell polarizing element and the region L1 between the outer-side polarizing elements, the −C components are within the tolerable range although being off the optimum value.

Therefore, the liquid crystal display panel 12 having the embodiment structure 2 also can achieve favorable black display.

Now, embodiment structures 2A and 2B, alternatives of the embodiment structure 2, are illustrated below. The embodiment structures 2A and 2B have almost the same structure as the embodiment structure 2. Here, the retardations of the liquid crystal layer 26 and the back-side biaxial film 52 are different.

That is, in the embodiment structure 2A, the liquid crystal layer 26 satisfies Rth=305 to 335 nm (preferably 310 to 330 nm) and the back-side biaxial film 52 satisfies Re=5 to 25 nm (preferably 10 to 30 nm) and Rth=−240 to −300 nm (preferably −260 to −280 nm). Thereby, an oblique contrast of 20 or higher can be secured.

In the embodiment structure 2B, the liquid crystal layer 26 satisfies Rth=275 to 305 nm (preferably 280 to 300 nm) and the back-side biaxial film 52 satisfies Re=5 to 25 nm (preferably 10 to 20 nm) and Rth=−190 to −250 nm (preferably −220 to −240 nm). Thereby, an oblique contrast of 20 or higher can be secured.

As above, the liquid crystal display panel of the second embodiment and the liquid crystal display panel having the embodiment structure 2, both provided with an in-cell polarizing element, achieve favorable viewing angle compensation.

In the second embodiment and the embodiment structure 2, the polarization conditions are not much different when the light passes through the in-cell polarizing element 50 and when the light passes through the front-side polarizing element 34. Therefore, favorable black display can be achieved without setting the level of compensation as in the first embodiment.

More specifically, in the case of employing a TAC film with Rth being substantially 0 nm (suitably −5 or greater, +5 nm or smaller) as the protective film 44, the following two conditions are preferably satisfied. The first condition is that the viewing angle compensation films are gathered between the back-side polarizing element 32 and the in-cell polarizing element 50. The second condition is that each of the thickness-direction phase difference between the back-side polarizing element 32 and the in-cell polarizing element 50 and the thickness-direction phase difference between the back-side polarizing element 32 and the front-side polarizing element 34 is set to be −20 nm or more and −40 nm or less from the optimum value.

### Third Embodiment

Hereinafter, a third embodiment is described. The structure of the liquid crystal display panel of the present embodiment is the same as that of the first embodiment, except the parts described in the present embodiment. For convenience of explanation, components having the same function as those described in the drawings for the first embodiment are indicated by the same reference signs, and explanation therefor is omitted.

A liquid crystal display panel 3 of the present embodiment is provided with a −C plate 56 instead of the back-side biaxial film 52, unlike the liquid crystal display panel 1 of the first embodiment. Here, the −C plate 56 is a negative film.

### (Comparative Structure 3)

First, a liquid crystal display panel 113 having a comparative structure 3 which does not have the in-cell polarizing element 50 is described based on FIG. 11, for comparison with the liquid crystal display panel of the present embodiment.

As illustrated in FIG. 11, the liquid crystal display panel 113 having the comparative structure 3 is provided with a −C plate 56 having an Rth of −240 nm instead of the back-side biaxial film 52, unlike the liquid crystal display panel 111 having the comparative structure 1.

The total −C component in the comparative structure 3 is 25 nm from −C plate=−240 nm, liquid crystal layer=320 nm, and protective film (TAC film)=−55 nm. Since favorable black display is achieved with this structure, the optimum −C component value for favorable black display is considered to be 25 nm.

In the liquid crystal display panel 113, viewing angle compensation is achieved between the outer-side polarizing elements (the back-side polarizing element 32 and the front-side polarizing element 34) (i.e., in the region L1 between the outer-side polarizing elements).

Accordingly, polarized light having entered the color filter 28 has a lower degree of polarization upon passing through the color filter 28. The light having a lower degree of polarization causes light leakage when passing through the front-side polarizing element 34 as an analyzer. That is, the contrast decreases.

### (Embodiment Structure 3)

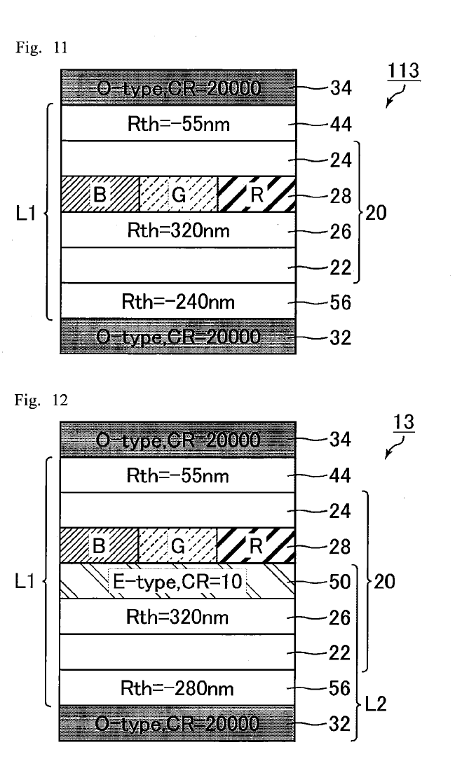

Hence, the liquid crystal display panel 13 having a structure (an embodiment structure 3) according to the third embodiment includes an in-cell polarizing element 50 (an E-type polarizing element) in the liquid crystal cell 20 as illustrated in FIG. 12, so that viewing angle compensation is provided in the region L2 between the back-side polarizing element and the in-cell polarizing element. For optimization of the viewing angle compensation in the region L2 between the back-side polarizing element and the in-cell polarizing element, a −C plate 56 exhibiting an optimized retardation, i.e., Rth=−280 nm, is provided.

As a result, the −C plate 56 and the liquid crystal layer 26 are sequentially provided in the region L2 between the back-side polarizing element and the in-cell polarizing element.

Here, the total −C component in the region L2 between the back-side polarizing element and the in-cell polarizer in the liquid crystal display panel 13 having the embodiment structure 3 is 40 nm from the −C plate=−280 nm and the liquid crystal layer=320 nm.

This value is within the tolerable range (±60 nm) from the optimum value (25 nm) described above.

The total −C component in the region L1 between the outer-side polarizing elements in the liquid crystal display panel 13 is −15 nm from −C plate=−280 nm, liquid crystal layer=320 nm, and protective film (TAC film)=−55 nm.

This value is within the tolerable range (±60 nm) from the optimum value (25 nm) described above. That is, the total Rth of the liquid crystal display panel 13 is −40 nm from the optimum value, which means that the viewing angle of the liquid crystal display panel 13 is compensated.

As above, also in the embodiment structure 3, the −C component (Rth) in the region L1 between the outer-side polarizing elements is smaller than the −C component (Rth) in the region L2 between the back-side polarizing element and the in-cell polarizer. In both of the region L2 between the back-side polarizing element and the in-cell polarizing element and the region L1 between the outer-side polarizing elements, the −C components are within the tolerable range although being off the optimum value.

Therefore, the liquid crystal display panel 13 having the embodiment structure 3 also can achieve favorable black display.

Now, embodiment structures 3A and 3B, alternatives of the embodiment structure 3, are illustrated below. The embodiment structures 3A and 3B have almost the same structure as the embodiment structure 3. Here, the retardations of the liquid crystal layer 26 and the −C plate 56 are different.

In the embodiment structure 3A, the liquid crystal layer 26 satisfies Rth=305 to 335 nm (preferably 310 to 330 nm) and the −C plate 56 satisfies Rth=−260 to −300 nm (preferably −270 to −290 nm). Thereby, an oblique contrast of 20 or higher can be secured.

In the embodiment structure 3B, the liquid crystal layer 26 satisfies Rth=275 to 305 nm (preferably 280 to 300 nm), and the −C plate 56 satisfies Rth=−240 to −280 nm (preferably −250 to −270 nm). Thereby, an oblique contrast of 20 or higher can be secured.

As above, the liquid crystal display panel of the third embodiment and the liquid crystal display panel having the embodiment structure 3, both provided with an in-cell polarizing element, achieve favorable viewing angle compensation.

In the third embodiment and the embodiment structure 3, the phase difference of the protective film 44 (phase difference of a TAC film) of the protective film 44 occurs. Therefore, similarly to the first embodiment, favorable black display is achieved by setting the level of compensation.

More specifically, in the case of employing a TAC film with Rth being −50 nm to −65 nm (suitably −55 to −60 nm) as the protective film 44, the following three conditions are preferably satisfied. The first condition is that the viewing angle compensation films are gathered between the back-side polarizing element 32 and the in-cell polarizing element 50. The second condition is that the thickness-direction phase difference between the back-side polarizing element 32 and the in-cell polarizing element 50 is set to be +5 nm or more and +25 nm or less from the optimum value. The third condition is that the thickness-direction phase difference between the back-side polarizing element 32 and the front-side polarizing element 34 is set to be −50 nm or more and −30 nm or less from the optimum value.

Here, the difference (shortage) from the optimum value of the thickness-direction phase difference between the back-side polarizing element 32 and the in-cell polarizing element 50 and the difference (excess) from the optimum value of the total thickness-direction phase difference between the back-side polarizing element 32 and the front-side polarizing element 34 are not necessarily the same, and can be respectively set to suitable values.

In the present embodiment, although the Rth of the protective film 44 is set to −55 nm (about −55 to about −60 nm), the Rth may be substantially 0 nm (suitably −5 nm or greater, +5 nm or smaller). In this case, since the Rth of the protective film 44 may be divided into the retardation before passing of the light through the in-cell polarizing element 50 and the retardation after passing of the light through the in-cell polarizing element 50, a value of −10 to −30 nm (suitably about −20 nm) may be added to the −C component of the region L2 between the back-side polarizing element and the in-cell polarizing element. That is, a value of −10 to −30 nm (suitably about −20 nm) may be added to the Rth of the −C plate 56.

The protective film 44 may be a TAC film having a thickness of 40 μm and Rth=−25 to −35 nm (suitably about −27 nm to about −30 nm). Also in this case, the Rth of the protective film 44 may be divided into the retardation before passing of the light through the in-cell polarizing element 50 and the retardation after passing of the light through the in-cell polarizing element 50.

### Fourth Embodiment

Hereinafter, the fourth embodiment is described. The structure of the liquid crystal display panel of the present embodiment is the same as that of the first embodiment, except the parts described for the present embodiment. For convenience of explanation, components having the same function as those described in the drawings for the first embodiment are indicated by the same reference signs, and explanation therefor is omitted.

A liquid crystal display panel 14 of the present embodiment has a +A plate 58 and the −C plate 56 in the region L2 between the back-side polarizing element and the in-cell polarizing element, unlike the liquid crystal display panel 1 of the first embodiment.

### (Comparative Structure 4)

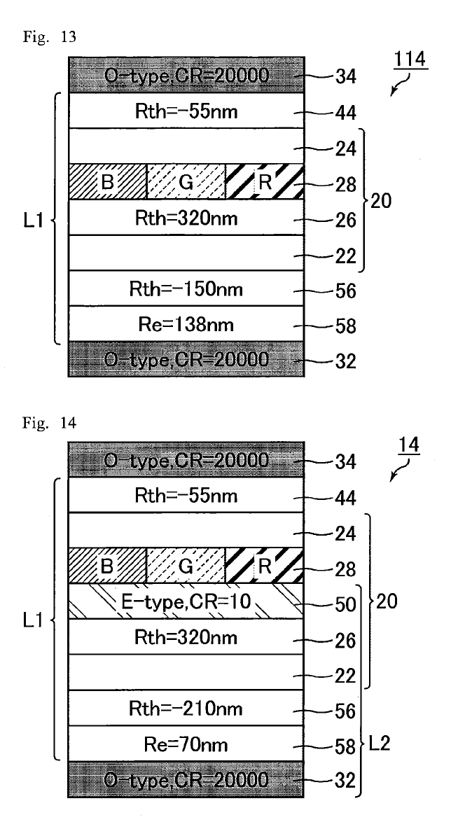

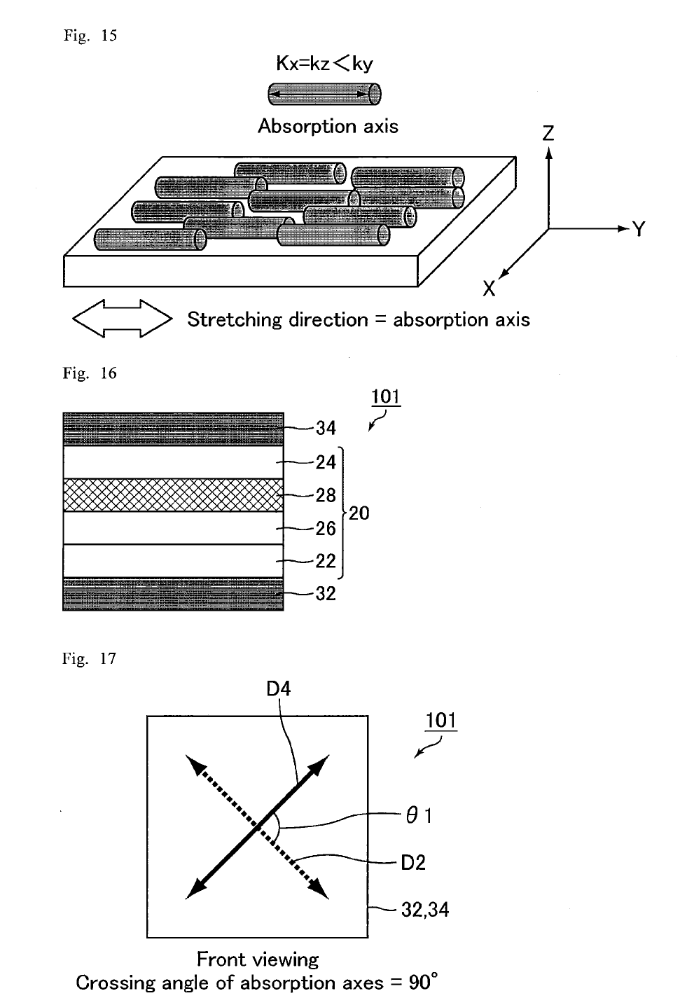

First, a liquid crystal display panel 114 having a comparative structure 4 which does not have the in-cell polarizing element 50 is described based on FIG. 13, for comparison with the liquid crystal display panel of the present embodiment.

In the liquid crystal display panel 114 without the in-cell polarizing element 50, a possible structure for viewing angle compensation using a viewing angle compensation film is a structure in which the −C plate 56 and the +A plate 58 are provided in the region L1 between the outer-side polarizing elements. FIG. 13 is a schematic cross-sectional view illustrating the lamination structure of the liquid crystal display panel having the comparative structure 4.

As illustrated in FIG. 13, the liquid crystal display panel 114 having the comparative structure 4 is not provided with the in-cell polarizing element 50, and is provided only with the back-side polarizing element 32 and the front-side polarizing element 34 as the polarizing elements.

As viewing angle compensation films, the +A plate 58 and the −C plate 56 are provided between the back-side substrate 22 and the back-side polarizing element 32. Here, in the comparative structure 4, the −C plate 56 used had an Rth of −150 nm, and the +A plate 58 used had an Re of 138 nm.

Such a comparative structure 4 suppresses occurrence of light leakage in the black state, enabling favorable black display.

The total −C component in the comparative structure 4 is 115 nm from −150 nm of the −C plate 56, 320 nm of the liquid crystal layer 26, and −55 nm of the protective film 44. That is, for favorable viewing angle compensation with this structure, the optimum value of the Rth is considered to be 115 nm.

In the liquid crystal display panel 114, viewing angle compensation is achieved between the outer-side polarizing elements (the back-side polarizing element 32 and the front-side polarizing element 34) (i.e., in the region L1 between the outer-side polarizing elements).

Accordingly, polarized light having entered the color filter 28 has a lower degree of polarization upon passing through the color filter 28. The light having a lower degree of polarization causes light leakage when passing through the front-side polarizing element 34 as an analyzer. That is, the contrast decreases.

### (Embodiment Structure 4)

Hence, a liquid crystal display panel 14 having a structure (an embodiment structure 4) according to the fourth embodiment has the in-cell polarizing element 50 (an E-type polarizing element) in the liquid crystal cell 20, so that viewing angle compensation is provided in the region L2 between the back-side polarizing element and the in-cell polarizing element. For optimization of the viewing angle compensation in the region L2 between the back-side polarizing element and the in-cell polarizing element, the +A plate 58 and the −C plate 56 each providing an optimized retardation are provided. More specifically, the +A plate 58 used had an Re of 70 nm, and the −C plate 56 used had an Rth of −210 nm.

As a result, the +A plate 58, the −C plate 56, and the liquid crystal layer 26 are sequentially provided in the region L2 between the back-side polarizing element and the in-cell polarizing element.

Here, the total −C component in the region L2 between the back-side polarizing element and the in-cell polarizer in the liquid crystal display panel 14 having the embodiment structure 4 is 110 nm from −C plate=−210 nm and liquid crystal layer=320 nm.

This value is within the tolerable range (±60 nm) from the optimum value (115 nm) described above.

The total −C component in the region L1 between the outer-side polarizing elements in the liquid crystal display panel 14 is 55 nm from −C plate=−210 nm, liquid crystal layer=320 nm, and protective film (TAC film)=−55 nm.

This value is within the tolerable range (±60 nm) from the optimum value (115 nm) described above. That is, the total Rth of the liquid crystal display panel 14 is −60 nm from the optimum value, which means that the viewing angle of the liquid crystal display panel 14 is compensated.

As above, also in the embodiment structure 4, the −C component (Rth) in the region L1 between the outer-side polarizing elements is smaller than the −C component (Rth) in the region L2 between the back-side polarizing element and the in-cell polarizer. In both of the region L2 between the back-side polarizing element and the in-cell polarizing element and the region L1 between the outer-side polarizing elements, the −C components are within the tolerable range although being off the optimum value.

Therefore, the liquid crystal display panel 14 having the embodiment structure 4 also can achieve favorable black display.

Now, embodiment structures 4A to 4D, alternatives of the embodiment structure 4, are illustrated below. The embodiment structures 4A to 4D have almost the same structure as the embodiment structure 4. Here, the retardations of the liquid crystal layer 26, the +A plate 58, and the −C plate 56 are different.

In the embodiment structure 4A, the liquid crystal layer 26 satisfies Rth=305 to 335 nm (preferably 310 to 330 nm), the +A plate 58 satisfies Re=10 to 30 nm (preferably 15 to 25 nm), and the −C plate 56 satisfies Rth=−240 to −300 nm (preferably −260 to −280 nm). Thereby, an oblique contrast of 20 or higher can be secured.

In the embodiment structure 4B, the liquid crystal layer 26 satisfies Rth=305 to 335 nm (preferably 310 to 330 nm), the +A plate 58 satisfies Re=60 to 80 nm (preferably 65 to 75 nm), and the −C plate 56 satisfies Rth=−200 to −260 nm (preferably −220 to −240 nm). Thereby, an oblique contrast of 20 or higher can be secured.

In the embodiment structure 4C, the liquid crystal layer 26 satisfies Rth=275 to 305 nm (preferably 280 to 300 nm), the +A plate 58 satisfies Re=10 to 30 nm (preferably 15 to 25 nm), and the −C plate 5 satisfies Rth=−220 to −280 nm (preferably −240 to −260 nm). Thereby, an oblique contrast of 20 or higher can be secured.

In the embodiment structure 4D, the liquid crystal layer 26 satisfies Rth=275 to 305 nm (preferably 280 to 300 nm), the +A plate 58 satisfies Re=60 to 80 nm (preferably 65 to 75 nm), and the −C plate 56 satisfies Rth=−170 to −230 nm (preferably −190 to −210 nm). Thereby, an oblique contrast of 20 or higher can be secured.

As above, the liquid crystal display panel of the fourth embodiment and the liquid crystal display panel having the embodiment structure 4, both provided with an in-cell polarizing element, achieve favorable viewing angle compensation.

In the fourth embodiment and the embodiment structure 4, the phase difference of the protective film 44 (phase difference of a TAC film) of the protective film 44 occurs. Therefore, similarly to the first embodiment, favorable black display is achieved by setting the level of compensation.

More specifically, in the case of employing a TAC film with Rth being −50 nm to −65 nm (suitably −55 to −60 nm) as the protective film 44, the following three conditions are preferably satisfied. The first condition is that the viewing angle compensation films are gathered between the back-side polarizing element 32 and the in-cell polarizing element 50. The second condition is that the thickness-direction phase difference between the back-side polarizing element 32 and the in-cell polarizing element 50 is set to be −15 nm or more and +5 nm or less from the optimum value. The third condition is that the thickness-direction phase difference between the back-side polarizing element 32 and the front-side polarizing element 34 is set to be −60 nm or more and −40 nm or less from the optimum value.

Here, the difference (shortage) from the optimum value of the thickness-direction phase difference between the back-side polarizing element 32 and the in-cell polarizing element 50 and the difference (excess) from the optimum value of the total thickness-direction phase difference between the back-side polarizing element 32 and the front-side polarizing element 34 are not necessarily the same, and can be respectively set to suitable values.

In the present embodiment, although the Rth of the protective film 44 is set to −55 nm (about −55 to about −60 nm), the Rth may be substantially 0 nm (suitably −5 nm or greater, +5 nm or smaller). In this case, since the Rth of the protective film 44 may be divided into the retardation before passing of the light through the in-cell polarizing element 50 and the retardation after passing of the light through the in-cell polarizing element 50, a value of −10 to −30 (suitably about −20 nm) may be added to the −C component of the region L2 between the back-side polarizing element and the in-cell polarizing element. That is, a value of −10 to −30 nm (suitably about −20 nm) may be added to the Rth of the −C plate 56.

The protective film 44 may be a TAC film having a thickness of 40 μm and Rth=−25 to −35 nm (suitably about −27 nm to about −30 nm). Also in this case, the Rth of the protective film 44 may be divided to the retardation before passing of the light through the in-cell polarizing element 50 and after passing of the light through the in-cell polarizing element 50.

As above, the liquid crystal display panels of the above respective embodiments and the liquid crystal display panels having the respective embodiment structures, each provided with an in-cell polarizing element, achieve favorable viewing angle compensation.

Since the tolerable range of the optimum solution of phase differences (Re, Rth) is comparatively narrow (range of ±10 nm), strict optical design is preferably made.

Also, the above-described difference between the optimum value and the residual phase difference is preferably within the predetermined range when the light passes through both of the first analyzer and the second analyzer. Specifically, the difference between the optimum value and the residual phase difference in the thickness direction is preferably in the range of ±60 nm.

Since the in-plane phase difference is set to a quite small value in the above embodiments and embodiment structures, considering only the optimum value of the Rth is not particularly problematic.

The present application claims priority to Patent Application No. 2009-285550 filed in Japan on Dec. 16, 2009 under the Paris Convention and provisions of national law in a designated State, the entire contents of which are hereby incorporated by reference.

### REFERENCE SIGNS LIST

1, 2, 3, 4, 11, 12, 13, 14, 101, 102, 103, 111, 112, 113,
114 Liquid crystal display panel
20 Liquid crystal cell
22 Back-side substrate (first substrate)
24 Front-side substrate (second substrate)
26 Liquid crystal layer
28 Color filter
32 Back-side polarizing element (first O-type polarizing element)
34 Front-side polarizing element (second O-type polarizing element)
36 Back-side phase difference film (viewing angle compensation film)
44 Protective film
46 Front-side phase difference film
50 In-cell polarizing element
52 Back-side biaxial film (viewing angle compensation film)
56 −C plate (viewing angle compensation film)+
58 +A Plate (viewing angle compensation film)

1. A liquid crystal display panel, comprising:
a first substrate;
a second substrate; and
a liquid crystal layer arranged between the first substrate and the second substrate,
the liquid crystal display panel including a first O-type polarizing element on an outer side of the first substrate,
the liquid crystal display panel including a second O-type polarizing element on an outer side of the second substrate,
the liquid crystal display panel including an E-type polarizing element between the second substrate and the liquid crystal layer on an inner side of the second substrate,
the liquid crystal display panel including viewing angle compensation film(s) between the first O-type polarizing element and the E-type polarizing element,
wherein a thickness-direction phase difference between the first O-type polarizing element and the second O-type polarizing element is equal to or smaller than the thickness-direction phase difference between the first O-type polarizing element and the E-type polarizing element.

2. The liquid crystal display panel according to claim 1, further comprising a protective film for the second O-type polarizing element between the E-type polarizing element and the second O-type polarizing element,
wherein a difference in a thickness-direction phase difference between the first O-type polarizing element and the second O-type polarizing element and between the first O-type polarizing element and the E-type polarizing element is substantially the same as a thickness-direction phase difference of the protective film.

3. The liquid crystal display panel according to claim 1,
wherein only a biaxial film constitutes the viewing angle compensation film(s).

4. The liquid crystal display panel according to claim 3, further comprising a protective film for the second O-type polarizing element between the E-type polarizing element and the second O-type polarizing element,
wherein the protective film has an absolute value of the thickness-direction phase difference of 50 to 65 nm,
the liquid crystal layer has a thickness-direction phase difference of 305 to 335 nm, and
the biaxial film has an in-plane phase difference of 0 to 30 nm and an absolute value of the thickness-direction phase difference of 210 to 290 nm.

5. The liquid crystal display panel according to claim 3, further comprising a protective film for the second O-type polarizing element between the E-type polarizing element and the second O-type polarizing element,
wherein the protective film has an absolute value of the thickness-direction phase difference of 50 to 65 nm,
the liquid crystal layer has a thickness-direction phase difference of 275 to 305 nm, and
the biaxial film has an in-plane phase difference of 0 to 30 nm and an absolute value of the thickness-direction phase difference of 180 to 260 nm.

6. The liquid crystal display panel according to claim 3, further comprising a protective film for the second O-type polarizing element between the E-type polarizing element and the second O-type polarizing element,
wherein the protective film has an absolute value of the thickness-direction phase difference of 5 nm or smaller,
the liquid crystal layer has a thickness-direction phase difference of 305 to 335 nm, and
the biaxial film has an in-plane phase difference of 5 to 25 nm and an absolute value of the thickness-direction phase difference of 240 to 300 nm.

7. The liquid crystal display panel according to claim 3, further comprising a protective film for the second O-type polarizing element between the E-type polarizing element and the second O-type polarizing element,
wherein the protective film has an absolute value of the thickness-direction phase difference of 5 nm or smaller,
the liquid crystal layer has a thickness-direction phase difference of 275 to 305 nm, and
the biaxial film has an in-plane phase difference of 5 to 25 nm and an absolute value of the thickness-direction phase difference of 190 to 250 nm.

8. The liquid crystal display panel according to claim 1,
wherein only a negative C plate constitutes the viewing angle compensation film(s).

9. The liquid crystal display panel according to claim 8, further comprising a protective film for the second O-type polarizing element between the E-type polarizing element and the second O-type polarizing element,
wherein the protective film has an absolute value of the thickness-direction phase difference of 50 to 65 nm,
the liquid crystal layer has a thickness-direction phase difference of 305 to 335 nm, and
the negative C plate has an absolute value of the thickness-direction phase difference of 260 to 300 nm.

10. The liquid crystal display panel according to claim 8, further comprising a protective film for the second O-type polarizing element between the E-type polarizing element and the second O-type polarizing element,
wherein the protective film has an absolute value of the thickness-direction phase difference of 50 to 65 nm,
the liquid crystal layer has a thickness-direction phase difference of 275 to 305 nm, and
the negative C plate has an absolute value of the thickness-direction phase difference of 240 to 280 nm.

11. The liquid crystal display panel according to claim 1,
wherein a positive A plate and a negative C plate which are provided between the first O-type polarizing element and the E-type polarizing element constitute the viewing angle compensation film(s).

12. The liquid crystal display panel according to claim 11, further comprising a protective film for the second O-type polarizing element between the E-type polarizing element and the second O-type polarizing element,
wherein the protective film has an absolute value of the thickness-direction phase difference of 50 to 65 nm,
the liquid crystal layer has a thickness-direction phase difference of 305 to 335 nm,
the positive A plate has an in-plane phase difference of 10 to 30 nm, and
the negative C plate has an absolute value of the thickness-direction phase difference of 240 to 300 nm.

13. The liquid crystal display panel according to claim 11, further comprising a protective film for the second O-type polarizing element between the E-type polarizing element and the second O-type polarizing element,
wherein the protective film has an absolute value of the thickness-direction phase difference of 50 to 65 nm,
the liquid crystal layer has a thickness-direction phase difference of 305 to 335 nm,
the positive A plate has an in-plane phase difference of 60 to 80 nm, and
the negative C plate has an absolute value of the thickness-direction phase difference of 200 to 260 nm.

14. The liquid crystal display panel according to claim 11, further comprising a protective film for the second O-type polarizing element between the E-type polarizing element and the second O-type polarizing element,
wherein the protective film has an absolute value of the thickness-direction phase difference of 50 to 65 nm,
the liquid crystal layer has a thickness-direction phase difference of 275 to 305 nm,
the positive A plate has an in-plane phase difference of 10 to 30 nm, and
the negative C plate has an absolute value of the thickness-direction phase difference of 220 to 280 nm.

15. The liquid crystal display panel according to claim 11, further comprising a protective film for the second O-type polarizing element between the E-type polarizing element and the second O-type polarizing element,
wherein the protective film has an absolute value of the thickness-direction phase difference of 50 to 65 nm,
the liquid crystal layer has a thickness-direction phase difference of 275 to 305 nm,
the positive A plate has an in-plane phase difference of 60 to 80 nm, and
the negative C plate has an absolute value of the thickness-direction phase difference of 170 to 230 nm.

16. The liquid crystal display panel according to claim 1, further comprising a color filter between the second substrate and the E-type polarizing element.

17. The liquid crystal display panel according to claim 2, wherein the protective film is a TAC film.

18. A liquid crystal display device comprising the liquid crystal display panel according to claim 1.

19. A liquid crystal display panel, comprising:
a first substrate;
a second substrate;
a liquid crystal layer arranged between the first substrate and the second substrate; and
a first O-type polarizing element, a viewing angle compensation film, an E-type polarizing element, and a second O-type polarizing element arranged in the stated order,
wherein the E-type polarizing element is arranged between the second substrate and the liquid crystal layer, and
a thickness-direction phase difference between the first O-type polarizing element and the second O-type polarizing element is equal to or smaller than the thickness-direction phase difference between the first O-type polarizing element and the E-type polarizing element.
